(19) United States
(12) Patent Application Publication
(10) Pub. No.: US 2010/0326465 A1
(43) Pub. Date: Dec. 30, 2010

(54) METHOD FOR THE REMOVAL OF SEDIMENTS, FOULING AGENTS AND THE LIKE FROM DUCTS AND TANKS, AND APPARATUS ADAPTED TO PERFORM THE SAID METHOD

(75) Inventor: Francesco MIRAGLIA, ARENZANO (GE) (IT)

Correspondence Address: MATTHIAS SCHOLL, 14781 MEMORIAL DRIVE, SUITE 1319, HOUSTON, TX, 77079, US

(73) Assignee: M.E.S. S.r.l., Arenzano (GE) (IT)

(21) Appl. No.: 12/879,202

(22) Filed: Sep. 10, 2010

Related U.S. Application Data
(62) Division of application No. 11/749,504, filed on May 16, 2007.

(51) Int. Cl. B08B 3/12

(52) U.S. Cl. 134/1

(57) ABSTRACT

Taught herein are a method and apparatus for removing sediments, fouling agents and the like from fluid, in particular liquid, ducts and/or tanks, characterized in that the method comprises applying an ultrasound vibration to a plurality of points of the structure, duct or tank to be treated, said ultrasound vibration being continuously applied outside the structure at a given frequency and power.

### CROSS-REFERENCE TO RELATED APPLICATIONS

This application is a divisional of U.S. Ser. No. 11/749,504 filed on May 16, 2007, now pending. The contents of the aforementioned specifications, including any amendments thereto, are incorporated herein by reference in their entirety.

### BACKGROUND OF THE INVENTION

1. Field of the Invention

This invention relates to a method for removing sediments, fouling agents, and the like, from ducts and tanks and to apparatus adapted for use in said method.

2. Description of the Related Art

Build-up of debris or fouling agents in ducts and/or tanks carrying or containing impure or otherwise sediment-generating liquids represents a common problem in many technological areas.

One of the fields most affected by this problem is ship-building, and particularly medium-high class pleasure boating. Inboard engines are provided with a seawater cooling systems wherein seawater is pumped up and subsequently discharged; seawater contains various micro-organisms of both animal and plant origin, which exhibit a tendency to establish and proliferate in cooling system ducts. This kind of sediments causes remarkable problems and damage to engine assemblies and has a high economic impact. The problem of sediment buildup can be solved by the use of washings with sodium hypochlorite solutions or other oxidizing agents capable of attacking such microorganisms. Of course, these chemical substances are environmental pollutants and their use is encountering more and more limitations.

### SUMMARY OF THE INVENTION

Accordingly, one aim of the present invention is to provide a method for removing sediments, fouling agents and the like from liquid ducts and/or tanks without using aggressive systems that can damage both the structure to be restored and the surrounding environment.

Another aim of the present invention is to provide an apparatus for carrying out a method for removing sediments, fouling agents and the like from liquid ducts and/or tanks without using aggressive systems that can damage both the structure to be restored and the surrounding environment, said apparatus being simply made and easily applied to various kinds of structures affected by similar problems due to sediments and fouling.

Thus, one object of the present invention is a method for removing sediments, fouling agents and the like from fluid, in particular liquid, ducts and/or tanks, characterized in that said method comprises applying ultrasound vibrations to a plurality of points of the structure, such as a duct or tank to be treated, said ultrasound vibration being continuously applied outside the structure at a given frequency and power.

Another object of the present invention is an apparatus for applying ultrasounds to a structure, such as a duct, tank or the like, comprising suitably-powered ultrasound generating means, transducer means for the ultrasounds generated from said ultrasound generating means, said transducer means being connected to said ultrasound generating means through connecting means and being coupled to said structure through suitable coupling elements.

In certain embodiments of the invention, a cleaning liquid is not used for removing sediments or fouling agents.

In certain embodiments of the invention, a cleaning fluid is not present between the transducer and the fluid duct.

In certain embodiments of the invention, ultrasound vibrations are provided in the form of non-convergent ultrasonic wave beams.

In certain embodiments of the invention, a majority of said ultrasound vibrations is provided in the form of non-convergent ultrasonic wave beams.

### BRIEF DESCRIPTION OF THE DRAWINGS

Other advantages and features of the present invention will be apparent from the following description of an embodiment thereof, which is provided by way of illustration, and not by way of limitation, with reference to the accompanying drawings, wherein:

FIG. 1 is a schematic representation of an embodiment of the apparatus according to the present invention; and

FIG. 2 is a detail of FIG. 1 showing a cross-section of a transducer assembly coupled to a duct.

### DETAILED DESCRIPTION OF THE INVENTION

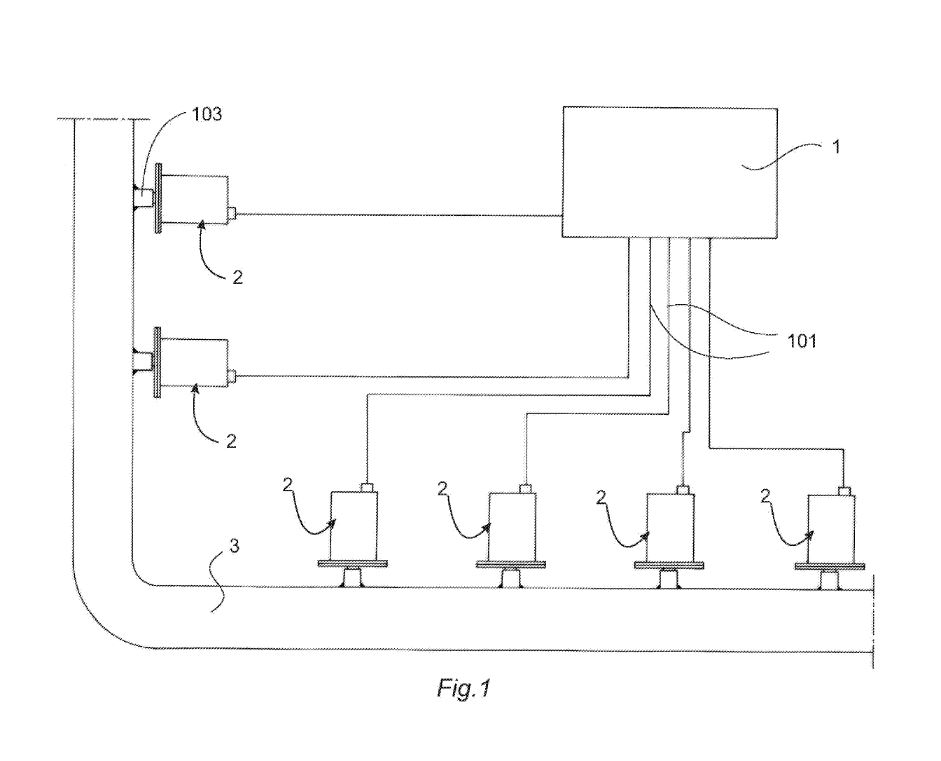

FIG. 1 illustrates an embodiment of an apparatus for carrying out the method according to the present invention; reference numeral 1 denotes an ultrasound generating unit which is connected, through a plurality of wires 101, to a plurality of transducer assemblies 2 which are coupled to a duct 3 through coupling elements 103.

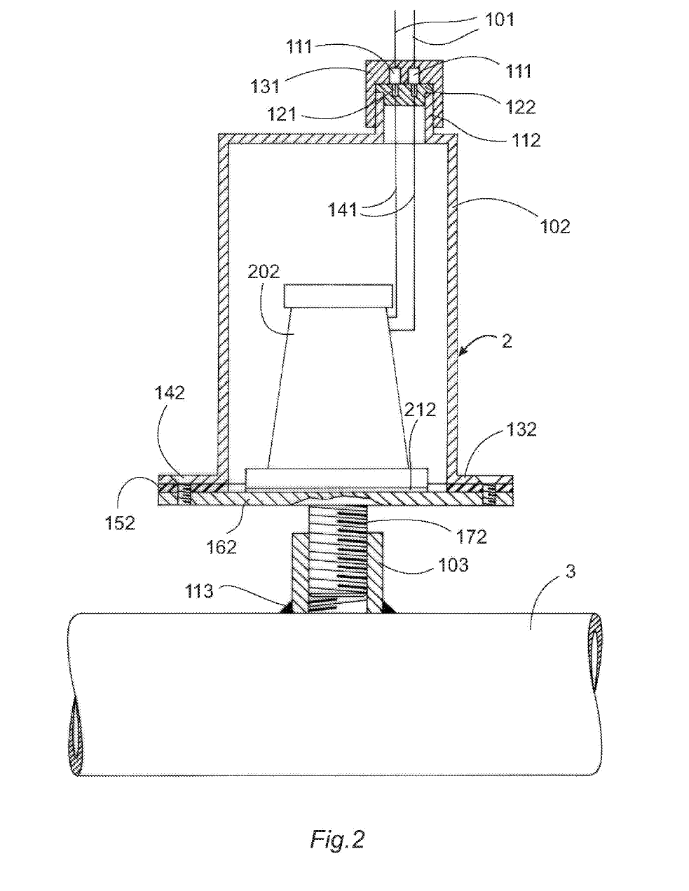

FIG. 2 shows a detail of one transducer assembly 2 coupled to the duct 3. The transducer assembly 2 comprises a substantially bell-shaped box-like body 102 whose open end is provided with a radially-projecting flange 132 for securing the body 102 to a plate 162 through screws 142. A transducer 202 is attached to the plate 162 through an adhesive resin layer 212, said transducer 202 being connected, through wires 141, to connectors 121 fitted in an insert 122 which engages the opening of a tube piece 112 at the bottom of the body 102 of the assembly 2. A cap 131 is mounted to the tube piece 112, and this cap houses connectors 111 for connecting wires 101 from the ultrasound generating unit 1 to the transducer assembly 2 (see FIG. 1). The plate 162 is axially provided with a threaded pin 172 which is coupled to a threaded sleeve 103 welded to the outer wall of said duct 3 through a welding seam 113; an annular sealing element 152 is provided between the plate 162 and the flange 142 of the body 102.

The method and apparatus for removing sediments, fouling agents and the like according to the present invention are further explained in the following. Taking the duct 3 as an example of a cooling duct for an inboard propulsion engine of a boat, build-up of fouling mainly due to microbiological components in seawater (phytoplankton, zooplankton) is a known problem; according to the method of the invention, this build-up can be prevented by continuously applying ultrasounds at a frequency in the range of 10 to 40 kHz, preferably in the range of 17 to 26 kHz, to the duct 3. The frequency of the applied vibration mainly depends on the wall thickness of the structure to be treated; generally, the larger the wall thickness, the higher the frequency of the applied vibrations. The power used is usually in the range of 300 Watts to 2 kilowatts, and preferably in the range of 600 Watts to 1,000 Watts. The application to this type of duct is only one among different examples of application for the method and apparatus according to the present invention, which can actually be used whenever a build-up of sediments and/or fouling agents exists in structures which contain and/or carry fluids.

The continuous application of ultrasound inhibits the formation of build-ups on the wall of the ducts and prevents the formation of fouling that can cause malfunctions in the cooling system. In this case, the main problem to be solved is how ultrasounds can be applied to the structure to be treated. In fact, it is necessary that vibration impacting the structure itself, e.g., a duct, is as smooth as possible, while avoiding that transducer means hinder the flow within the structure and that the morphology of the structure is dramatically modified. Furthermore, because of the substantially circular cross-section of a duct, it is necessary that vibration is effectively and completely transferred to the highest degree without substantially changing the structure of transducers. To achieve these results, the unique transducer is fitted into a transducer assembly of suitable construction such as to be coupled with the structure to be treated in a very simple way, said structure having in turn been modified to a very small extent. In order to install the transducer assembly in a stable and perfectly functional way according to the invention, a threaded sleeve is welded to the external surface of the duct.

The transducer itself is housed in a substantially sealed container body 102, and it is attached to a face of a plate through a suitable adhesive such as an epoxy resin, a polystyrene resin or the like, said plate being coupled to the sleeve which is welded to the duct. In this way, vibration is transferred to the duct, and this type of connecting system is well suited for structures greatly varying in shape and size, so as to allow for a wide use of the method and apparatus according to the present invention.

Advantageously, the transducer assembly 2 is connected to wires 101 through connecting means 111, 121 which enable its complete removal and replacement. Moreover, the insert 122 in the tube piece 112, along with the cap 131, further assure sealing within the transducer assembly 2 and prevent wear thereof due to the action of external agents.

What is claimed is:

1. A method for removing sediments or fouling agents from a structure having a plurality of points, said structure being selected from a fluid duct and/or a fluid tank, said method comprising: attaching an apparatus for applying ultrasounds to said structure, and applying ultrasound vibrations to said plurality of points, wherein said apparatus comprises: power generating means, and transducer means powered by said power generating means, said transducer means being connected to said power generating means through connecting means and being coupled to said structure by coupling a first coupling element with a second coupling element; wherein said transducer means comprises: a transducer assembly comprising a container body which contains a transducer element, said transducer element being connected to the inner face of a wall of said container body, and said first coupling element is provided on the outer face of said wall and said second coupling element is secured to said structure; wherein attaching said apparatus to said structure comprises coupling said first coupling element with said second coupling element; and wherein said ultrasound vibrations are continuously applied outside said structure at a given frequency and a given power.

2. The method of claim 1, wherein said frequency is in the range of from 10 to 40 kHz.

3. The method of claim 2, wherein said frequency is in the range of 17 to 26 kHz.

4. The method of claim 1, wherein the power absorbed during the application of said ultrasounds is critically in the range of 100-2,000 Watts.

5. The method according to claim 4, wherein the power absorbed during the application of said ultrasounds is critically in the range of 600-1,000 Watts.

6. The method according to claim 1, wherein a cleaning liquid is not used for removing sediments or fouling agents.

7. The method according to claim 1, wherein a cleaning fluid is not present between said transducer and said fluid duct.

8. The method according to claim 1, wherein said ultrasound vibrations are provided in the form of non-convergent ultrasonic wave beams.

9. The method according to claim 1, wherein a majority of said ultrasound vibrations is provided in the form of non-convergent ultrasonic wave beams.

10. A method for preventing build-up of sediments or fouling agents within a structure having a plurality of points, said structure being selected from a fluid duct and/or a fluid tank, said method comprising: attaching an apparatus for preventing build-up of sediments or fouling agents within a fluid duct to the outside of said structure, and applying ultrasound vibrations to said plurality of points; wherein said apparatus comprises: a plurality of ultrasound transducer assemblies and a power supply unit for supplying power to said transducer assemblies; wherein said fluid duct is outfitted with a plurality of threaded sleeves welded to the outside of the fluid duct along its length; wherein said transducer assemblies each comprise a sealed box-shaped container body with a plate, a transducer element attached to said plate on the inside of said container body, and a threaded pin attached to said plate on the outside of said container body, said threaded pin being adapted to be connected to said threaded sleeve and to immobilize the apparatus with respect to the fluid duct, and said threaded pin being disposed directly across from said transducer on the opposite side of said plate; wherein attaching said apparatus to the outside of said structure comprises connecting said threaded pin with said threaded sleeve; wherein said apparatus produces ultrasound waves having a frequency of between 17 kHz and 26 kHz and prevents build-up of sediments or fouling agents within a fluid duct; and wherein said ultrasound waves are continuously applied outside said structure.

11. The method of claim 10, wherein the power absorbed by the structure during the application of said ultrasounds is in the range of 100-2,000 Watts.

12. The method according to claim 11, wherein the power absorbed during the application of said ultrasounds is in the range of 600-1,000 Watts.

13. The method of claim 10, wherein said ultrasound vibrations propagate through said threaded pin and said threaded sleeve, and a cleaning fluid is not present between said transducer and said fluid duct.

14. The method according to claim 10, wherein a cleaning liquid is not used for removing sediments or fouling agents.

15. The method according to claim 10, wherein a cleaning fluid is not present between said transducer and said fluid duct.

16. The method according to claim 10, wherein said ultrasound vibrations are provided in the form of non-convergent ultrasonic wave beams.

17. The method according to claim 10, wherein a majority of said ultrasound vibrations is provided in the form of non-convergent ultrasonic wave beams.
